(19) United States
(12) Patent Application Publication
(10) Pub. No.: US 2010/0265615 A1
(43) Pub. Date: Oct. 21, 2010

(54) STORAGE DEVICE

(75) Inventors: Hideki YAMAGUCHI, Sagamihara-shi (JP); Kouichi TOUKAIRIN, Kawasaki-shi (JP); Hirofumi SUZUKI, Fuchu-shi (JP); Hiroaki KOBAYASHI, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/752,940

(22) Filed: Apr. 1, 2010

Related U.S. Application Data
(63) Continuation of application No. PCT/JP2007/069165, filed on Oct. 1, 2007.

(51) Int. Cl. G11B 17/02

(52) U.S. Cl. 360/99.12; G9B/17.002

(57) ABSTRACT

According to one embodiment, a storage device includes a clamp ring on a disc, configured to fix the disc to a spindle motor configured to rotate the disc, and a screw configured to fix the clamp ring to the spindle motor, and includes a screw-head and a recess in the screw-head, a center of the recess being decentered from a center of the screw-head.

### CROSS-REFERENCE TO RELATED APPLICATIONS

This is a Continuation Application of PCT Application No. PCT/JP2007/069165, filed Oct. 1, 2007, which was published under PCT Article 21(2) in Japanese.

### BACKGROUND

1. Field

One embodiment of the invention relates to a storage device comprising a spindle assembly including a disc, clamp ring, and spindle motor.

2. Description of the Related Art

In an HDD, in reply to a demand for larger capacity in recent years, the track pitch of a disc is made smaller, and the number of discs is increased, and further, in order to respond to a demand for high-speed recording, the rotational speed of the spindle motor is increased. A plurality of discs are arranged on a hub of the spindle motor through a spacer, and are thereafter fixed by screwing a clamp ring on the disc to the hub.

In a high-recording density disc, a high degree of head positioning accuracy is required, and hence it becomes necessary to suppress vibration and deformation applied to the disc. One of the factors causing the vibration and deformation is imbalance of the spindle assembly. Thus, it is proposed in Jpn. Pat. Appln. KOKAI Publication No. 11-134840 to correct the imbalance by utilizing a clamp ring including imbalance substantially identical with the imbalance of the main part of the spindle motor. Further, putting the disc or spacer to one side, and adhering a counterweight to the clamp ring are also conceivable.

However, it is difficult to prepare a clamp ring including imbalance substantially identical with the imbalance of the spindle motor main part as described in Jpn. Pat. Appln. KOKAI Publication No. 11-134840. Further, assembly to be carried out after putting the disc or spacer to one side requires reassembly of parts, and hence this is also a troublesome matter. Further, when the weight is adhered, the clamp ring cannot be reused. As described above, a demand for simpler correction of the imbalance has been made from before.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view showing the internal structure of an HDD as an example of the present invention;

FIG. 2 is an exemplary partial cross-sectional view of the vicinity of a spindle motor shown in FIG. 1;

FIG. 3A is an exemplary perspective view of an eccentric screw shown in FIG. 1;

FIG. 3B is an exemplary top view of the eccentric screw shown in FIG. 1;

FIG. 3C is an exemplary side view of the eccentric screw shown in FIG. 1;

FIG. 4 is an exemplary graph showing a relationship between a rotation angle and clamping force of the eccentric screw shown in FIG. 3A;

FIG. 5A is an exemplary top view of a modification example of the eccentric screw shown in FIG. 3A;

FIG. 5B is an exemplary side view of a modification example of the eccentric screw shown in FIG. 3;

FIG. 6 is an exemplary view showing imbalance distribution states of a case where an ordinary non-eccentric screw is used, and case where the eccentric screw shown in FIG. 3 is used;

FIG. 7 is an exemplary partial perspective view of a modification example of the HDD shown in FIG. 1;

FIG. 8 is an exemplary plan view for explaining imbalance correction using the eccentric screw shown in FIG. 7; and

FIG. 9 is an exemplary flowchart for explaining a manufacturing method of the HDD shown in FIG. 7.

### DETAILED DESCRIPTION

Various embodiments according to the invention will be described hereinafter with reference to the accompanying drawings. In general, according to an aspect of the invention, there is provided a storage device comprising: a clamp ring on a disc, configured to fix the disc to a spindle motor configured to rotate the disc; and a screw configured to fix the clamp ring to the spindle motor, and comprising a screw-head and a recess in the screw-head, a center of the recess being decentered from a center of the screw-head.

In such a storage device, it is possible to easily correct imbalance of the spindle assembly only by adjusting the rotation angle of the screw in which a center of a recess is decentered from a center of a screw-head.

In the storage device, the clamp ring may be fixed to the spindle motor through a plurality of screws, and a pair of screws of the plurality of screws be rotated from a position at which imbalances of the plurality of screws are balanced with respect to a center of the clamp ring by angles equal to each other in absolute value in directions opposite to each other. This makes it possible to correct the imbalance at the time of assembly without causing new imbalance in the spindle assembly. The screw may include a spring washer. This makes it possible to reduce the variation in clamping force resulting from the decentered position of the screw-head. It is desirable that the screw be constituted of a tungsten alloy or the like. The tungsten alloy comprises specific gravity of 10 to 10.8 g/cm³, which is relatively large, and hence the alloy provides a remarkable imbalance correction effect.

According to another aspect of the invention, a method of manufacturing a storage device comprises: acquiring an imbalance of a spindle assembly comprising a disc, a clamp ring, and a spindle motor, the clamp ring being on the disc and fixed to the clamp ring by screws in such a manner that imbalances of the screws are balanced with respect to a center of the clamp ring; and rotating the screws, attached to the clamp ring and spindle motor and comprising a screw-head and a recess in the screw-head, a center of the recess being decentered from a center of the screw-head, so as to reduce the imbalance of the spindle assembly.

According to such a manufacturing method of a storage device, it is possible to easily correct imbalance of the spindle assembly only by adjusting the rotation angle of the screw in which a center of a recess is decentered from a center of a screw-head.

It is desirable that a step of selecting the above-mentioned screw from a plurality of types of screws different from each other in the eccentricity between the center of the recess and center of the screw-head be further provided. This makes it possible to effectively reduce the imbalance of the spindle assembly.

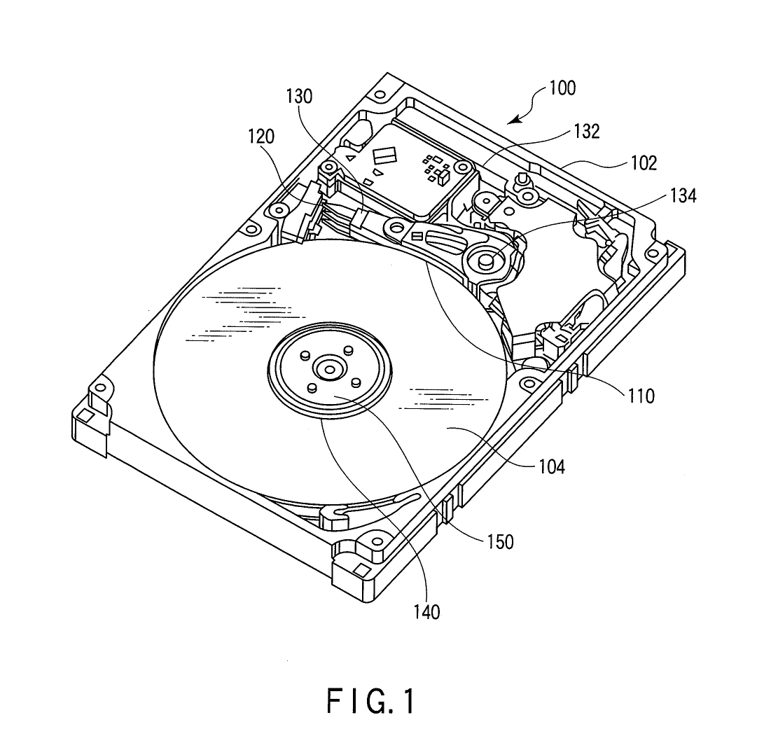

An HDD as an example of a storage device of the present invention will be described below by referring to the accompanying drawings. FIG. 1 is a perspective view of the inside of the HDD 100. As shown in FIG. 1, in the HDD 100, one or a plurality of magnetic discs 104 as a recording medium or media, head stack assembly (HSA) 110, spindle motor 140, and clamp ring 150 are arranged in a housing 102.

The housing 102 is constituted of, for example, an aluminum die-cast base or the like, is formed into a rectangular parallelepiped-shape, and a cover (not shown) configured to seal up the internal space is coupled thereto. The magnetic disc 104 of this embodiment has a high surface recording density of, for example, 100 Gb/in² or more. The magnetic disc 104 has a diameter of, for example, 2.5 inches, and is attached to a hub of the spindle motor 140 through a hole provided in the center thereof.

The HSA includes a magnetic head section 120, suspension 130, and carriage 132.

The magnetic head section 120 includes a slider, and a head joined to an air outflow end of the slider, and used for read/write. The head is exemplarily an MR inductive combined head. The MR inductive combined head comprises an inductive write head element configured to write binary information to the magnetic disc 104 by utilizing a magnetic field induced by a conductive coil pattern (not shown), and magnetoresistive effect head element configured to read binary information on the basis of the resistance changing according to a magnetic field acting from the magnetic disc 104.

The suspension 130 supports the magnetic head section 120, and applies elastic force to the magnetic head section 120 against the magnetic disc 104. The carriage 132 is swung around a pivot 134 by a voice coil motor (not shown). The carriage 132 has a substantially E-shaped cross section, and hence is also called an E block or actuator (AC) block. A support part of the carriage 132 is called an arm.

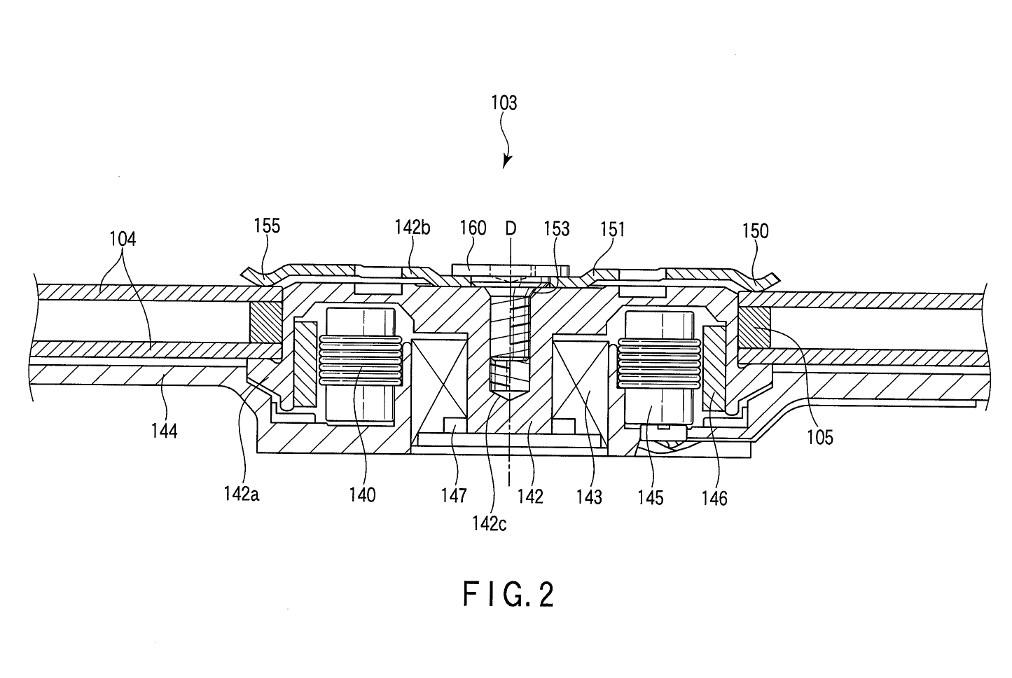

FIG. 2 is a partial cross-sectional view of the vicinity of the spindle motor 140. The spindle motor 140 rotates the magnetic disc 104 at a high speed of, for example, 10000 rpm. The spindle motor 140 includes, as shown in FIG. 2, a hub 142, sleeve 143, bracket (base) 144, core 145, magnet 146, and annular thrust plate 147.

The hub 142 supports the disc 104 by a flange 142a. Further, the hub 142 comprises an annular mounting surface 142b on which a main body 151 of the clamp ring 150 is to be mounted on the top thereof, and a threaded hole 142c at the center thereof.

The sleeve 143 is a member in which the hub 142 is to be rotatably fitted, and is fixed to the inside of the housing 102. The hub 142 is rotated, whereas the sleeve 143 is not rotated, and constitutes a fixed part together with the bracket 144. A groove (crevice) configured to introduce a lubricant is formed in the sleeve 143. When the hub 142 is rotated, dynamic pressure (fluid pressure) is generated in the lubricant along the groove (radial bearing).

The bracket (base) 144 is fixed to the housing 102 at a part around the sleeve 143, and supports a core (coil) 145, magnet 146, and yoke (not shown). A current is made to flow around the core 145, and the core 145, magnet 146, and yoke serving also as the hub constitute a magnetic circuit. The magnetic circuit is opposed to the voice coil motor of the carriage, and is used to swing the head. The thrust plate 147 is arranged at the central part of the lower end of the sleeve, and forms a thrust bearing supporting the load of the hub 142 in the longitudinal direction. The radial bearing is a pressure bearing configured to support the hub 142 through the lubricant in a non-contacting manner, and supports the load of the hub 142 in the radial direction.

The spacer 105 is arranged between the two discs 104 adjacent to each other, and maintains the gap between the discs.

The clamp ring 150 fixes the discs 104 and spacer 105 to the spindle motor, and is constituted of an annular disc-like main body 151. The main body 151 is screwed to the hub 142, and includes a screw-insertion hole 153 provided in the center thereof, and disc retaining section 155. The disc retaining section 155 is an annular member provided at a lower circumferential part of the main body 151, and configured to retain the discs 104. A screw (eccentric screw) 160 fixes the main body 151 to the hub 142. The screw 160 specifies the (disc-) clamping force acting to fix the discs 104 to the hub 142 by being screwed onto the hub 142. The clamping force is transmitted to the disc retaining section 155 by pressing the part at which the seating face of the screw 160 is in contact with the peripheral part of the screw-insertion hole 153.

It should be noted that a reference symbol 103 shown in FIG. 2 denotes a spindle assembly. The spindle assembly 103 includes the discs 104, spindle motor 140, and clamp ring 150. In this example, an imbalance of the spindle assembly is corrected by utilizing the screw 160.

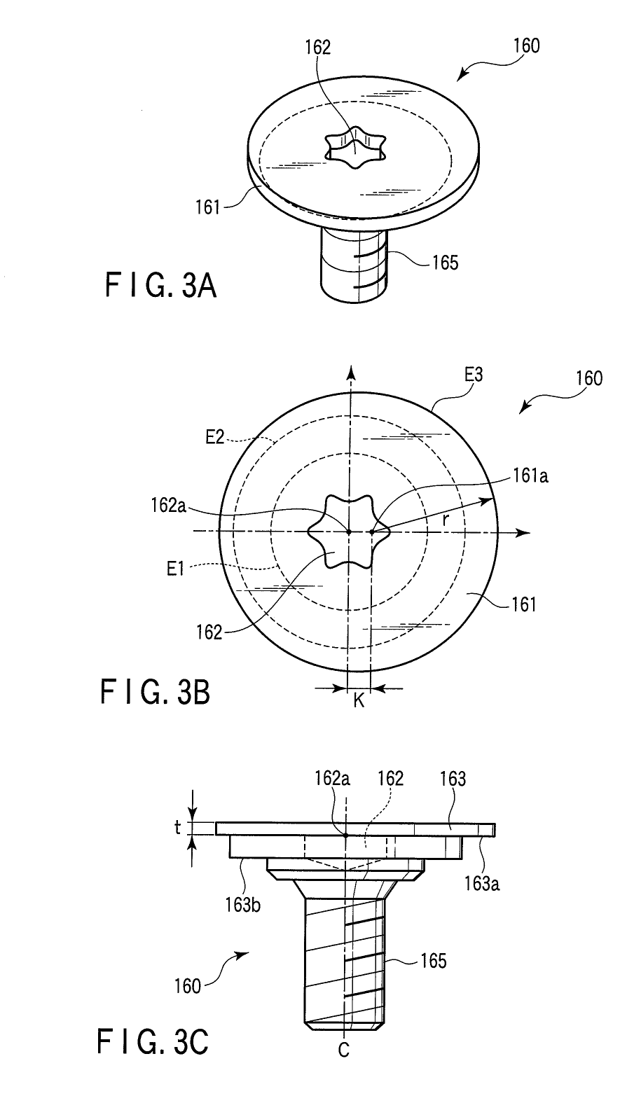

The screw 160 configured to fix the main body 151 to the hub 142 is inserted into the screw-insertion hole 153. It should be noted that the number of the screw-insertion hole 153 is not limited to one, and may be three, four, and six. FIGS. 3A, 3B, and 3C are a perspective view, an upper surface, and a sectional view, showing the screw 160. The screw 160 includes a screw-head 161 and thread part 165.

In this example, although the screw-head 161 comprises a flat shape, the shape is not limited, and the screw-head may comprise a pan-head-shape, hexagonal-head-shape, and the like. Although the screw-head 161 includes a recess 162 of an asterisk-shape, the shape of the recess 162 is not limited, and the recess 162 may comprise a cross-shape, slot-shape, and the like. A bit of a screwdriver (not shown) is fitted into the recess 162, whereby the screw 160 is screwed into a threaded hole 142c of the hub 142.

When the center 162a of the recess 162 is defined as the center of the asterisk-shape shown in FIG. 3B, the center 162a of the recess 162 is on the centerline C of the thread part 165, and hence the center 162a functions as the rotation center at the time of screwing. Further, as shown in FIG. 3B, when an orthogonal coordinate including the center 162a of the recess as an origin is described, and concentric circles E1 and E2 comprising the center 162a of the recess as the centers are described. Then, it is understood that the center 162a of the recess 162 is decentered from the center 161a of the screw-head 161. The center 161a of the screw-head 161 is the center of the outer circle E3 shown in FIG. 3B. The concentric circles E1 and E2 are not concentric with the outer circle E3, and circle E3 protrudes in the X direction when viewed from circle E2. As shown in FIGS. 3B and 3C, in the seating face 163 of the screw-head 161, an end part 163a thereof in the direction (X direction) from the center 162a of the recess 162 toward the center 161a of the screw-head 161 is farther from the center 162a of the recess 162 than the end part 163b in the opposite direction. The center of gravity of the screw 160 is shifted in accordance with a difference between the distance from the center 162a of the recess 162 to the end part 163b and distance from the center 162a of the recess 162 to the end part 163a.

The thread part 165 is the part of the screw 160 to be screwed into the threaded hole 142c of the hub 142.

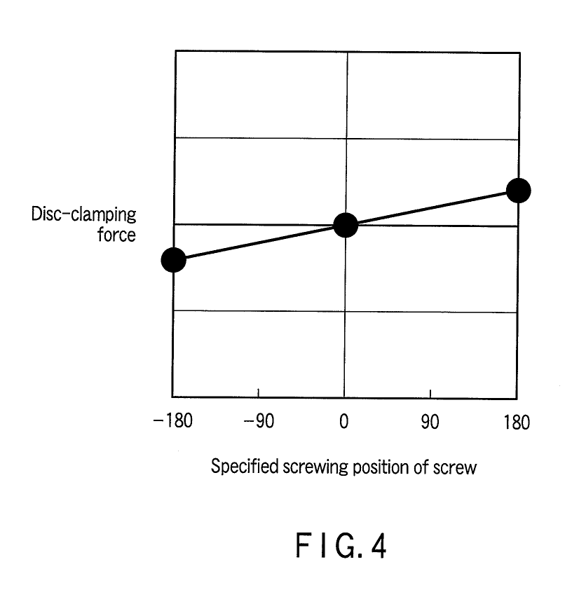

As a result of this, when the screw 160 is screwed into the threaded hole 142c of the hub 142 by the bit (not shown), clamping force is generated according to the rotation angle of the screw 160 as shown in FIG. 4. Here, FIG. 4 is a graph showing the relationship between the screwing position (rotation angle) of the screw 160 and clamping force.

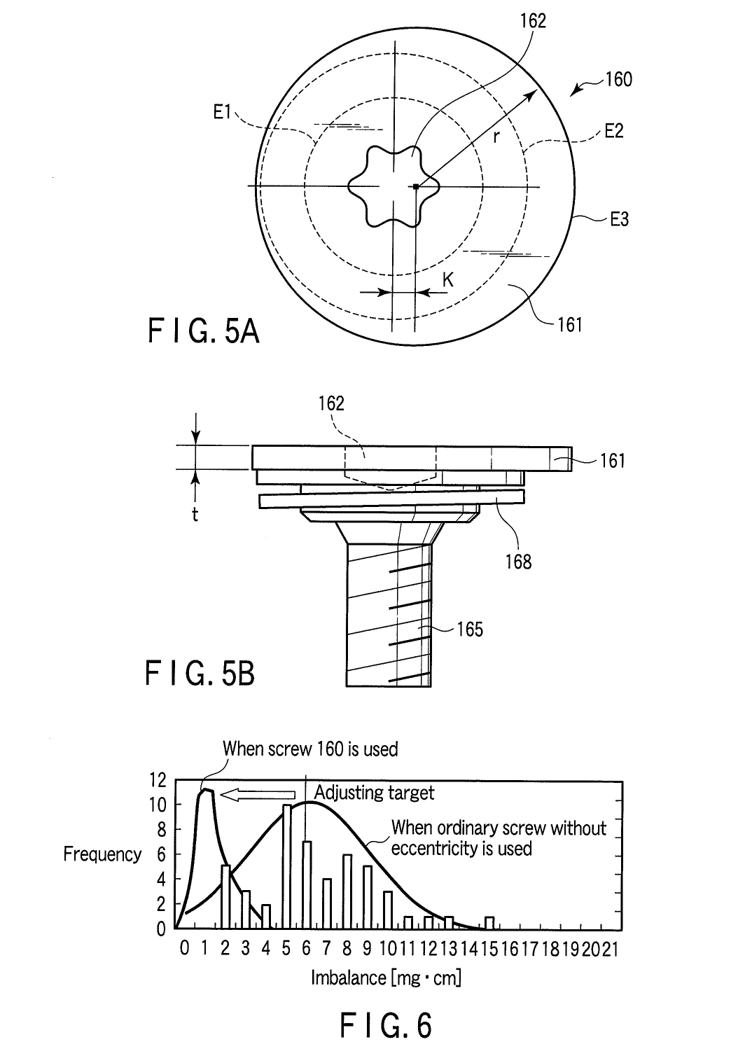

FIGS. 5A and 5B are a top view and side view each showing a case where a spring washer 168 is added to the screw 160. As a result of this, the spring washer 168 can reduce the variation in clamping force resulting from the decentered position of the screw-head shown in FIG. 4.

In FIG. 6, the imbalance from the center of the hub 142 is shown on the abscissa, and frequency (number of HDD samples) is shown on the ordinate, whereby the imbalance distribution characteristics of a case where an ordinary screw which is not decentered is used, and the imbalance distribution characteristics of a case where the screw 160 is used are shown. The ordinary screw which is not decentered implies a screw in which the center of the recess and center of the screw-head coincide with each other. FIG. 6 shows that when the maximum value of the histogram is taken at a position from the center of the hub 142 located on the straight line D shown in FIG. 2, an imbalance of 6 mg is present. According to FIG. 6, it can be seen that there exists no sample without imbalance (0 mg/cm). As described above, imbalance is present in the conventional spindle assembly 103 without exception, and hence even when only one screw 160 configured to add an eccentric load to the spindle assembly 103 in a certain direction is used, the addition of the screw 160 is effective for the correction of the imbalance of the spindle assembly 103.

Here, in FIG. 6, the value of 6 mg.cm which is the peak of the distribution of imbalance is made the target. A tungsten-based alloy with specific gravity s of 10.6 g/cm³ is used as the material for the screw 160, radius of the screw-head is set at 0.3 cm, thickness t is set at 0.05 cm, and eccentricity is set as k. The specific gravity of the tungsten alloy is 10 to 18.8 g/cm³, which is relatively large, provides a remarkable imbalance correction effect, and is therefore desirable. Then, πr²ts=150 mg is obtained. The eccentricity k corresponds to a counterweight of 60 mg.mm.

As described above, when the screw 160 of this example is used, the imbalance is reduced as indicated by an arrow shown in FIG. 6.

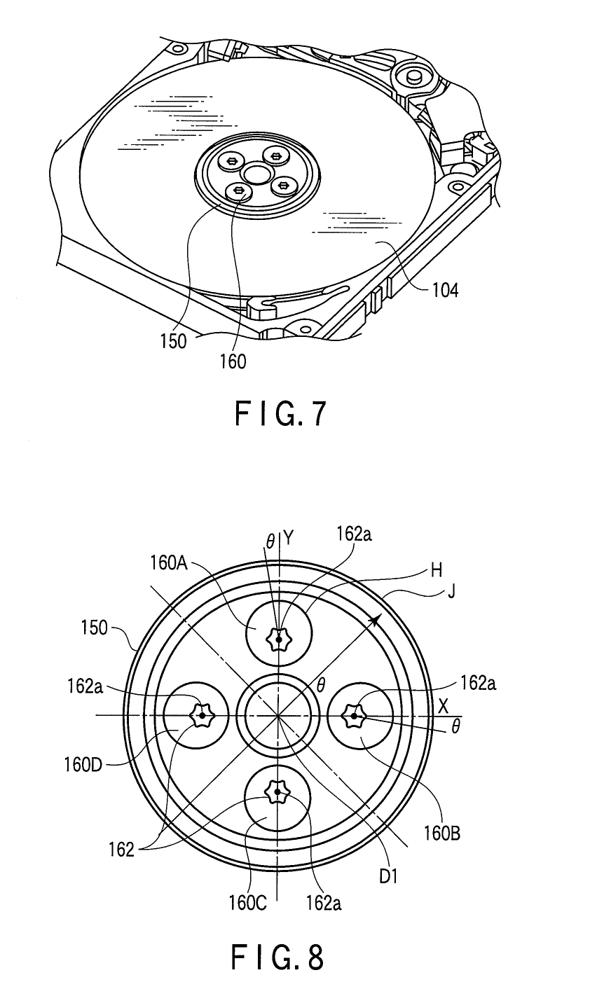

FIG. 7 is a perspective view showing an example in which imbalance is corrected by inserting four screws 160 into four screw-insertion holes provided on the same circle instead of fixing the disc by using a screw-insertion hole in the center of the clamp ring 150. FIG. 8 is a plan view for explaining a method of correcting imbalance by using four screws 160 (in FIG. 8, these screws are distinguished from each other as 160A to 160D).

Referring to FIG. 8, an orthogonal coordinate including the center D1 of the clamp ring 150 as an origin is set in such a manner that the X- or Y-axis passes through the center 162a of the recess 162 of each screw 160. Now, an imbalance of each screw 160 is set as H (mg.mm), and imbalance in the direction of an angle θ is set as J (mg.mm). The angle θ is set in steps of 45°, and the imbalance direction of J is approximated by the eight directions. This is because the values of θ′ of the screws 160A and 160B are made identical with each other. At first, as shown in FIG. 8, all the screws 160 are set in such a manner that the center 162a of the recess 162 is closest to the center D1 of the clamp ring 150. Needless to say, all the screws 160 may be set in such a manner that the center 162a of the recess 162 is farthest from the center D1 of the clamp ring. In this state, imbalances of all the screws 160 are balanced with each other in the X and Y directions when viewed from the center D1 of the clamp ring 150. Alternatively, the imbalances of the screws 160 are canceled out by each other around the center D1 of the clamp ring 150, or the moment around the center D1 of the clamp ring 150 is zero.

From this state, the screw 160A is rotated counterclockwise by an angle θ′, and screw 160B is rotated clockwise by the angle θ′ without changing the positions of the screws 160C and 160D. When the imbalance J (mg.mm) in the direction of the angle θ is resolved into the imbalance Jx in the X direction, and imbalance Jy in the Y direction, the following result is obtained.

Jx=J·cos θ

Jy=J·sin θ

Next, when the imbalance H (mg.mm) given by the screw 160A is resolved into the imbalance Hxa in the X direction, and imbalance Hya in the Y direction, the following result is obtained.

Hxa=H·sin θ′

Hya=H−H·con θ′

Next, the imbalance H (mg.mm) given by the screw 160B is resolved into the imbalance Hxb in the X direction, and imbalance Hyb in the Y direction, the following result is obtained.

Hxb=H−H·cos θ′

Hyb=H·sin θ′

Then, the following formulas are established with respect to the X and Y directions.

Jx=Hxa+Hxb

Jy=Hya+Hyb

J·cosθ=H·sinθ′+H−H·cosθ′

J·sinθ=H−H·conθ′+H·sinθ′

As described above, it is possible to correct the imbalance J by utilizing formula 5.

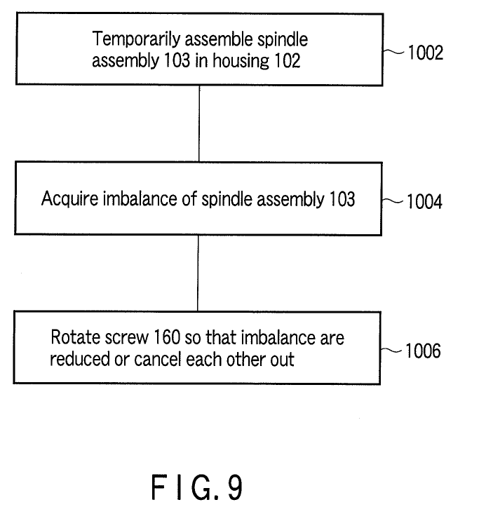

FIG. 9 is a flowchart for explaining the manufacturing method of the HDD 100.

First, the spindle assembly 103 is temporarily assembled in the housing 102 (step 1002). The term “temporary assembly” implies a state before imbalance correction.

Then, the imbalance of the spindle assembly 103 is acquired (step 1004).

In step 1004, the imbalance of the spindle assembly 103 may be acquired by actually measuring the imbalance of the spindle assembly 103 assembled in step 1002. In such measurement, an acceleration sensor can be used. For example, the housing 102 on which the spindle assembly 103 is mounted is placed on a table arranged on the floor through a spring member, and the spindle motor 140 is rotated. An acceleration sensor is attached to the table. The acceleration sensor detects vibration of both the housing 102 at the time of driving the spindle motor 140, and vibration of the table. In this case, an advantage that the imbalance of the spindle assembly 103 can be individually corrected with a high degree of accuracy is obtained.

When the imbalance of the spindle assembly 103 is actually measured, there is further a step of determining, from the measurement result, whether or not the imbalance is within the allowable range. When the imbalance is within the allowable range, the imbalance correction is terminated, and other members such as the HSA 110 and the like are mounted on the housing 102. When the imbalance is out of the allowable range from the measurement result, an imbalance correction step is carried out.

Data to be obtained in step 1004 is (1) data of the spindle assembly 103 in which the clamp ring 150 is fixed by an ordinary screw (screw in which the center 162a of the recess 160 and the center 161a of the screw-head 161 coincide with each other), or (2) data of the spindle assembly 103 in which imbalances applied by the screws 160 are balanced or canceled out by each other around the center D1 of the clamp ring 150 like in the state before the rotation of the angle θ′ shown in FIG. 8, or data of the spindle assembly 103 in which the moment around the center D1 of the clamp ring 150 is zero. It should be noted that in the case of one screw in the center, the imbalance may be measured while the eccentric screw is fixed as it is, and the imbalance may be reduced by rotating the screw.

Next, the rotation of the screw 160 is calculated (step 1006). For example, when four screws 160 are used, the rotation of the screw 160 is calculated from formulas 5.

Next, the screw 160 is rotated in such a manner that the imbalances are reduced or canceled out by each other (step 1006). In the case of above (1), the ordinary screw is replaced with the screw 160, and the spindle assembly 103 is rotated while the screw 160 is attached thereto as it is. In the case of above (2), the screw 160 is rotated toward the end.

In step 1004, when the actual measurement result is used, it is desirable that a plurality of types of screws 160 different from each other in the eccentricity between the center 162a of the recess 162 and center 161a of the screw-head 161 be prepared, and a step of selecting a screw that can minimize the imbalance from the prepared screws on the basis of the measured or stored imbalance be provided. This makes it possible to effectively reduce the imbalance of the spindle assembly 103.

As the need arises, the imbalance may be measured again by using an acceleration sensor or the like, and it may be determined whether or not the imbalance is within the allowable range. In that case, when the imbalance is still outside the allowable range, it is possible to carry out error display or use a screw 160 comprising another eccentricity.

In the operation of the HDD, the imbalance of the spindle assembly 103 is reduced to a value within the allowable range, and hence it is possible to maintain a high degree of head positioning accuracy.

In this example, by replacing the conventionally used screw fixing the clamp ring 150 with an eccentric screw 160, and rotating the screw 160 by a set angle, it is possible to easily correct the imbalance of the spindle assembly.

While certain embodiments of the invention have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

What is claimed is:

1. A storage device comprising:
a clamp ring on a disc, configured to attach the disc to a spindle motor configured to rotate the disc; and
a screw configured to attach the clamp ring to the spindle motor, and comprising a screw-head and a recess in the screw-head, a center of the recess being decentered from a center of the screw-head.

2. The storage device of claim 1, wherein the clamp ring is attached to the spindle motor through a plurality of screws, and
a pair of screws of the plurality of screws is rotated from a position where the plurality of screws are balanced with respect to a center of the clamp ring by angles substantially equal to each other in an absolute value in directions opposite to each other.

3. The storage device of claim 1, wherein the screw comprises a spring washer.

4. The storage device of claim 1, wherein the screw is formed of a tungsten alloy.

5. A storage device comprising:
a disc
a clamp ring on the disc, configured to attach the disc to a spindle motor configured to rotate the disc; and
a screw configured to attach the clamp ring to the spindle motor, and comprising a screw-head and a recess in the screw-head, a center of the recess being decentered from a center of the screw-head.

6. The storage device of claim 5, wherein the clamp ring is attached to the spindle motor through a plurality of screws, and
a pair of screws of the plurality of screws is rotated from a position where the plurality of screws are balanced with respect to a center of the clamp ring by angles substantially equal to each other in an absolute value in directions opposite to each other.

7. The storage device of claim 5, wherein the screw comprises a spring washer.

8. The storage device of claim 5, wherein the screw is formed of a tungsten alloy.

9. A method of manufacturing a storage device comprising:
calculating a degree of an imbalance of a spindle assembly comprising a disc, a clamp ring, and a spindle motor, the clamp ring being on the disc and attached to the clamp ring by screws and balancing the screws with respect to a center of the clamp ring,
rotating the screws, attached to the clamp ring and spindle motor and comprising a screw-head and a recess in the screw-head, a center of the recess being decentered from a center of the screw-head, in order to reduce the degree of the imbalance of the spindle assembly.

10. The method of claim 9, further comprising selecting a screw from a plurality of types of screws different from each other in an eccentricity between the center of the recess and the center of the screw-head on the basis of the imbalance.
